(19) United States
(12) Patent Application Publication
(10) Pub. No.: US 2026/0289190 A1
(43) Pub. Date: Sep. 24, 2026

(54) TRANSLATION METHOD BASED ON AN AI BUSINESS CARD, DEVICE AND TRANSLATION SYSTEM

(71) Applicant: Meet Today Technology INC, SACRAMENTO, CA (US)

(72) Inventors: CHAO PENG, SACRAMENTO, CA (US); DAN MA, SACRAMENTO, CA (US)

(21) Appl. No.: 19/084,868

(22) Filed: Mar. 20, 2025

(51) Int. Cl. G06F 40/58; G06F 9/54; G06F 21/44; H04W 4/80

(52) U.S. Cl. CPC G06F 40/58; G06F 9/543; G06F 21/44; H04W 4/80

(57) ABSTRACT

This application discloses a translation method based on an AI business card, device and translation system. The method includes: sending a first instruction information to a terminal device, the terminal device responds to the first instruction information, collects audio to obtain first audio data, and sends the first audio data to a server, the server is used to translate the first audio data to obtain a translation result and send the translation result to the terminal device; receiving the translation result and outputting the translation result through a currently running application.

### FIELD

The present disclosure relates to the field of natural language processing technology, and in particularly to a translation method based on an AI business card, device and translation system.

### BACKGROUND

With the rapid development of electronic technology, electronic devices have been widely used. Audio translation software can be installed on electronic devices. Correspondingly, users can use the audio translation software installed on electronic devices for voice translation. Currently, in scenarios such as business expansion, conference communication, and interpersonal communication, users can usually use audio translation software for voice translation. However, in scenarios such as exhibitions and academic conferences, participants may have different preferences for using applications such as social software and conference software. Users often need to copy and paste the translation results into different applications after the voice translation is completed. It can be seen that the current translation efficiency of electronic devices is relatively low.

### SUMMARY

A translation method based on an AI business card, device and translation system disclosed in this application address the issue of low translation efficiency of electronic devices in related technologies, enhancing the translation efficiency and convenience of electronic devices.

In the first aspect, this application provides a translation method based on an AI business card, applied to a terminal device, including:

receiving first instruction information sent by an AI business card, wherein the AI business card is attached to the terminal device, the AI business card is provided with a trigger button, and the AI business card sends the first instruction information to the terminal device when the trigger button is triggered;

responding to the first instruction information, and collecting audio to obtain first audio data;

sending the first audio data to a server, wherein the server is used to translate the first audio data to obtain a translation result, and send the translation result to the terminal device; and

receiving the translation result and outputting the translation result through a currently running application.

In the second aspect, this application provides a translation method based on an AI business card, applied to an AI business card, including:

sending a first instruction information to a terminal device, wherein the AI business card is attached to the terminal device, the AI business card is provided with a trigger button, and the AI business card sends the first instruction information to the terminal device when the trigger button is triggered; the terminal device responds to the first instruction information, collects audio to obtain first audio data, and sends the first audio data to a server, the server is used to translate the first audio data to obtain a translation result and send the translation result to the terminal device;

sending a second instruction information to the terminal device, wherein the AI business card sends the second instruction information to the terminal device when the trigger button is triggered again or the trigger state is released, the terminal device responds to the second instruction information and stops to collect audio.

In the third aspect, this application provides a terminal device, the terminal device includes:

a memory, configured to store a computer program;

a processor, configured to execute the computer program and implement the translation method based on an AI business card as described in any embodiment of this application when executing the computer program.

In the fourth aspect, this application provides an AI business card, configured to implement the translation method based on an AI business card as described in any embodiment of this application, wherein the AI business card includes:

a housing;

a communication module, through which the AI business card establishes a communication connection with a terminal device, and the communication module includes a Bluetooth module or an NFC module;

a trigger button, the trigger button is provided on the housing, configured to make the AI business card send first instruction information when triggered, or send second instruction information when triggered again or when the trigger state is released.

In the fifth aspect, this application provides a translation system, the translation system includes a terminal device, an AI business card, and a server; the AI business card is detachably attached to the terminal device and is in communication connection with the terminal device; the terminal device is in communication connection with the server; the terminal device is used to implement the translation method based on an AI business card as described in any embodiment of this application, and the AI business card is used to implement the translation method based on an AI business card as described in any embodiment of this application.

In the sixth aspect, this application provides a computer-readable storage medium, the computer-readable storage medium stores a computer program, when the computer program is executed by a processor, the processor implements the translation method based on an AI business card as described in any embodiment of this application.

The translation method based on an AI business card provided in this application realizes the translation function, especially the cross-application translation function, according to the instruction information sent by the AI business card. It can avoid cumbersome operations and inconveniences such as continuously switching the software display interface and repeatedly copying and pasting information between the translation software and other applications, and enhance the translation efficiency of electronic devices.

It should be understood that the above general description and the following detailed description are merely exemplary and explanatory, and shall not limit this application.

### BRIEF DESCRIPTION OF THE DRAWINGS

In order to clearly illustrate the technical solutions in the embodiments of this application, the following will briefly introduce the drawings used in the description of the embodiments. Apparently, the drawings in the following description are some embodiments of this application. For those of ordinary skill in the art, without making any creative efforts, other drawings can be obtained based on these drawings.

FIG. 1 is a structural schematic diagram of a translation system provided in an embodiment of this application.

FIG. 2 is a structural schematic diagram of an AI business card provided in an embodiment of this application.

FIG. 3 is an exploded structural schematic diagram of an AI business card from the first perspective provided in an embodiment of this application.

FIG. 4 is an exploded structural schematic diagram of an AI business card from the second perspective provided in an embodiment of this application.

FIG. 5 is a structural schematic diagram of an AI business card attached to a terminal device provided in an embodiment of this application.

FIG. 6 is a structural schematic diagram of a terminal device provided in an embodiment of this application.

FIG. 7 is a schematic flowchart of a translation method based on an AI business card provided in an embodiment of this application.

FIG. 8 is a schematic diagram of the display interface of a first application provided in an embodiment of this application.

FIG. 9 is a schematic diagram of the display interface of a second application provided in an embodiment of this application.

FIG. 10 is a schematic diagram of the display interface of another second application provided in an embodiment of this application.

FIG. 11 is a schematic diagram of the display of a video communication interface provided in an embodiment of this application.

FIG. 12 is a schematic diagram of the display of a language switching interface provided in an embodiment of this application.

FIG. 13 is a schematic flowchart of a translation method based on an AI business card provided in an embodiment of this application.

FIG. 14 is a schematic flowchart of a translation method based on an AI business card provided in an embodiment of this application.

### EXPLANATION OF THE MARKS IN THE DRAWINGS

100, translation system; 10, AI business card; 11, housing; 12, communication module; 13, trigger button; 14, attachment piece; 20, mobile terminal; 21, first widget; 22, second widget; 23, third widget; 24, fourth widget; 25, fifth widget; 26, pop - up window widget; 30, server.

It should be understood that the above general description and the following detailed description are merely exemplary and explanatory, and shall not limit this application.

### DETAILED DESCRIPTION

The technical solution of embodiments of this application is clearly and completely described in connection with the accompanying drawings. Apparently, described embodiments are some embodiments of this application, not all embodiments. Based on embodiments of this application, all other embodiments obtained by those of ordinary skill in the art without creative efforts are within the scope of this application.

The flowcharts shown in the drawings are merely for illustrative purposes. They do not necessarily include all the content and operations/steps, nor do they have to be executed in the described order. For example, some operations/steps can be further split, combined, or partially merged, so the actual execution order may change according to the actual situation.

It should be understood that the terms used in the specification of this application are merely for the purpose of describing specific embodiments and are not intended to limit this application. As used in the specification of this application and the appended claims, unless the context clearly dictates otherwise, the singular forms "a", "an", and "the" are intended to include the plural forms.

It should be understood that, in order to clearly describe the technical solutions of the embodiments of this application, in the embodiments of this application, terms such as "first" and "second" are used to distinguish identical or similar items with basically the same functions and effects. For example, the first data and the second data are only used to distinguish different data, and there is no limitation on their sequence. Those skilled in the art can understand that terms such as "first" and "second" do not limit the quantity or the execution order, and terms such as "first" and "second" do not necessarily mean that they are different.

It should be further understood that the term "and/or" used in the specification and the claims of this application refers to any combination and all possible combinations of one or more of the items listed in association, and includes these combinations.

The following is a detailed description of some embodiments of this application in connection with the accompanying drawings. In no conflicting situations, the embodiments and features within the embodiments described below can be combined with each other.

With the rapid development of electronic technology, terminal devices such as mobile phones, tablets, and AR glasses have won the favor of a large number of users, and have brought about the vigorous development of the technology, market and ecology of information applications such as social media, news forums, podcast broadcasts, and chat tools. In the related technologies, users can often install translation software on terminal devices to translate the content of various information applications, or use the basic translation functions built into some applications for translation. However, since some applications do not have a built-in basic translation function, or the built-in basic translation function is single in function or weak in translation quality, it cannot meet the diverse translation needs of users, such as a plurality of languages, technical terms, voice-to-text conversion, and voice-to-voice conversion.

Therefore, users are often accustomed to using traditional translation software for translation, which also leads to the need for users to constantly switch between software display interfaces, and copy and paste the information in the translation software into the target application through the clipboard. This not only reduces the translation efficiency but also brings a lot of inconvenience. For example, in scenarios such as business exhibitions and academic conferences, participants are likely to come from all over the world and have different preferences for using applications such as social software and conference software. During the online communication after users add the other sides' contact information, they often need to use a certain translation software to convert the source language into the target language, and then copy and paste the target language into different application software. This is not only cumbersome to operate and inefficient in communication, but also prone to errors. Obviously, the translation efficiency of current electronic devices is relatively low. Specifically, the main reasons for the relatively low translation efficiency include the following aspects:

First, when users use different information application software such as social media, news forums, podcast broadcasts, and chat tools, since they need to operate a certain translation software to obtain translation results, they have to constantly switch between the interfaces of the application software and the translation software, and use the clipboard to copy and paste. This reduces the translation efficiency of the electronic device.

Second, a small number of information application software have built-in translation functions. However, on the one hand, among various information application software where users may have translation needs, such as video calls, chat tools, online forums, or social media, the proportion of information application software with built-in translation functions is relatively limited. When it is necessary to contact communication partners using other information application software without translation functions, traditional translation software still needs to be used for translation. On the other hand, the translation functions of different information application software often vary in usage methods. Therefore, the translation efficiency of electronic devices remains limited.

Third, traditional translation software, especially those on mobile phones, are operated entirely through the touch screen, buttons of the terminal device or a certain peripheral device. As a result, the human-machine interaction interface is easily hijacked by disguised viruses, leading to problems such as being secretly recorded and having the bandwidth occupied. This not only reduces the security of the device but also decreases the stability and smoothness of the system operation, thus lowering the translation efficiency of the electronic device.

Fourth, traditional translation software, especially that on translators, often integrates the translation system into a single translator or does not allow users to freely switch translation service providers. However, different translation software vendors have varying levels of translation capabilities for different languages and professional fields. To ensure high - quality translation, especially in scenarios such as international exhibitions where on - site translation services in a plurality of languages are required, users often need to test, select, and switch between a plurality of translation software. This not only lacks flexibility but also reduces the translation efficiency of electronic devices. Another example is that in some professional translation scenarios, when users need customized translation services such as customizing glossaries and building and training translation agents, traditional translation software has difficulty in providing support, which limits the translation efficiency of electronic devices.

Fifth, traditional translators often require the integration of electronic components such as network communication modules, audio collection modules, and computility units in the device. On the one hand, this makes the hardware cost of the translator relatively high and the device larger in size. On the other hand, it also places higher requirements on the supporting power supply of the translator, further increasing the hardware cost of translators and size of the device. In particular, with the trend of miniaturization of electronic devices, the volume of terminal devices is often limited, and their supporting power supplies also need to be miniaturized. This reduces the endurance of devices such as translators, causing users to sometimes need to suspend the current translation task for charging, which lowers the translation efficiency of electronic devices.

Sixth, when the audio collection task is executed by a traditional external translator, frequent and large-volume communication between the terminal device and the external translator is required, which not only occupies the communication bandwidth of both the terminal device and the external translator but also makes the external translator have higher requirements for electronic components such as the power supply and communication module. Under the same cost expenditure, this reduces the translation efficiency of the electronic device.

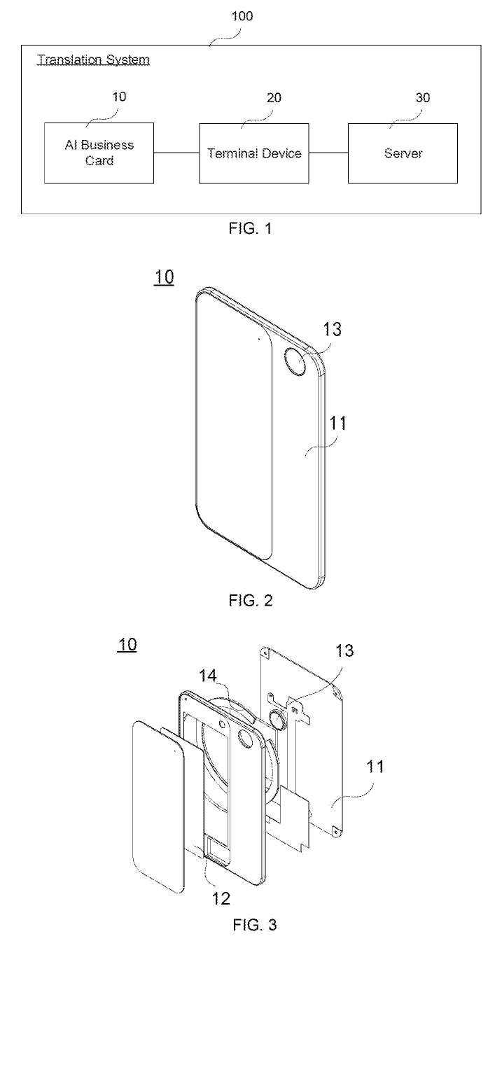

To solve the above problems, an embodiment of this application provides a translation system. As shown in FIG. 1, FIG. 1 is a structural schematic diagram of a translation system provided in an embodiment of this application. The translation system 100 is used to execute the translation method based on an AI business card provided in the embodiment of this application. The translation system 100 can include an AI business card 10, a terminal device 20, and a server 30. Wherein the server 30 can be a single server 30 or can include a plurality of servers 30, and no limitation is imposed here.

In some embodiments, the AI business card 10 is in communication connection with the terminal device 20, and the communication connection can be achieved through near-field communication technology. The terminal device 20 can be in communication connection with the server 30, and the communication connection can be realized through a network.

In some embodiments, the AI business card 10 can be detachably attached to the terminal device 20. With such an arrangement, it will be more convenient for users to use the AI business card, repair it, or detach it for activities such as charging.

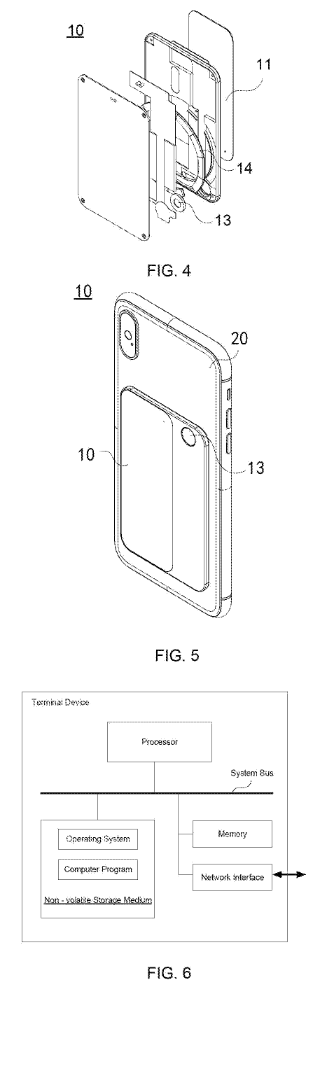

Please refer to FIGS. 2 to 4. FIG. 2 is a structural schematic diagram of an AI business card provided in an embodiment of this application. FIG. 3 is an exploded structural schematic diagram of an AI business card from the first perspective provided in an embodiment of this application. FIG. 4 is an exploded structural schematic diagram of an AI business card from the second perspective provided in an embodiment of this application. The AI business card 10 can include a housing 11, a communication module 12, and a trigger button 13. Wherein the communication module 12 can be used to make the AI business card 10 establish a communication connection with the terminal device 20; The communication module 12 can include a Bluetooth module or an NFC module; The trigger button 13 can be provided on the housing 11 and is used to make the AI business card 10 send first instruction information when triggered, or send second instruction information when triggered again or when the trigger state is released. Wherein the first instruction information may include a translation instruction, an audio collection instruction, and/or an instruction to send the first audio data to the server; the second instruction information may include a translation stop instruction, a paste instruction, and/or an audio collection stop instruction.

Please also refer to FIG. 5. FIG. 5 is a structural schematic diagram of an AI business card attached to a terminal device provided in an embodiment of this application. As shown in FIGS. 3 to 5, the AI business card 10 may further include an attachment piece 14. The attachment piece 14 is used to make the AI business card 10 be detachably attached to the terminal device 20 via the attachment piece 14. Wherein the attachment piece 14 may include magnetic components, hook-and-loop fasteners, micro suction cups, or rubber sleeves, etc.

With such an arrangement, the AI business card 10 can be attached to the terminal device. This not only makes the AI business card 10 less likely to be lost, avoiding the risk of being easily lost due to its miniaturization, but also enables users to conveniently operate the translation function with a single-handed grip when using the terminal device 20 such as a mobile phone, thus improving the translation efficiency of the terminal device 20. In addition, since the AI business card 10 can be detachably attached to the terminal device 20 through the attachment piece 14, it will be more convenient for users to use the AI business card 10, repair the AI business card 10, or detach the AI business card 10 for activities such as charging.

Please refer to FIG. 6. FIG. 6 is a structural schematic diagram of a terminal device provided in an embodiment of this application. The translation method based on an AI business card provided in an embodiment of this application can also be implemented in the form of a computer program; this computer program can run on the terminal device as shown in FIG. 6. The terminal device can be configured as a mobile communication device, a tablet PC, AR glasses, a VR device, a computer, or a translator. As shown in FIG. 6, the terminal device may include a memory and a processor. Wherein the memory can be used to store a computer program, and the processor can be used to execute the computer program and implement the translation method based on an AI business card as described in any embodiment of this application when executing the computer program, specifically the translation method applied to the terminal device.

It should be understood that, the processor can be a central processing unit (CPU), and the processor can also be other general-purpose processors, a digital signal processor (DSP), an application specific integrated circuits (ASIC), a field-programmable gate array (FPGA), or other programmable logic devices, discrete gate or transistor logic devices, discrete hardware components, etc. Wherein the general-purpose processor can be a micro-processor, or be any conventional processor, etc.

It is understood by those skilled in the art that the structures shown in FIG. 6 is merely some of the structures related to this application and do not constitute a limitation on the terminal device to which the solution of this application is applied. The specific terminal device can include more or fewer components than those shown in the figure, or combine certain components, or have a different component layout.

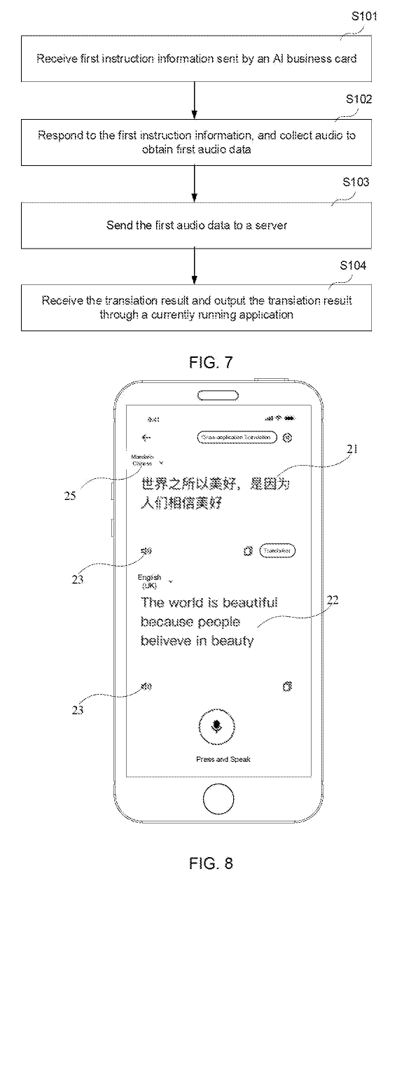

A translation method based on an AI business card is provided in an embodiment of this application. The translation method based on an AI business card can be applied to a terminal device. Please refer to FIG. 7, FIG. 7 is a schematic flowchart of a translation method based on an AI business card provided in an embodiment of this application. As shown in FIG. 7, the method includes the following steps.

In step 101, receive first instruction information sent by an AI business card.

Wherein the AI business card can be attached to the terminal device; the AI business card is provided with a trigger button, and the AI business card can send the first instruction information to the terminal device when the trigger button is triggered. For example, the trigger button can be configured as a toggle button, a sliding button, a temperature-sensing button, a pressure-sensing button, a touch button, a capacitive button, or a virtual button, and no specific limitation is imposed here. For example, the first instruction information may include an audio collection instruction or a translation instruction, and the first instruction information can be sent via NFC, Bluetooth, WIFI, cellular data, etc., and no specific limitation is made here.

In some embodiments, the AI business card may include a Bluetooth module and an NFC module. Wherein the AI business card can establish an encrypted communication connection with the terminal device through the Bluetooth module, and can send business card information to the terminal device via the NFC module. The business card information includes web links, content information, or log information.

With such an arrangement, in the first aspect, the function of the AI business card is realized by sending content information, avoiding problems such as the difficulty in managing and preserving traditional paper business cards and their lack of environmental friendliness. In the second aspect, the transmission of business card information can be indirectly achieved by sending web links. Thus, on the premise of keeping the hardware cost of the AI business card relatively controllable and its structure simple and compact, it becomes possible for the business card information to include multimedia contents such as photos and portfolios, which can better save the hardware costs of device components such as memory, computility, communication modules, etc. In the third aspect, in some sales management systems, the log information of the business card information may include reading or access records. Employers can confirm the salespersons' customer visit records or itinerary records by reading the log information in the AI business cards equipped by the employed salespersons, and formulate incentive, welfare, management and business strategies in a data-driven manner. In the fourth aspect, when the log information of the business card information includes reading, access or permission records, and the user's AI business card is stolen, the owner of the AI business card can be found by reading the relevant business card information, and the relevant business card information can be used as judicial evidence.

In some embodiments, the first instruction information can also include authentication information. The terminal device can perform authentication based on the authentication information sent by the AI business card; if the authentication result is unsuccessful, the step in response to the first instruction information will not be executed. With such an arrangement, on the one hand, it can control information security risks, prevent hackers from misappropriating the translation service by imitating the first instruction information, and avoid losses to the translation service provider. On the other hand, it can prevent hackers from communicating with the terminal device through forged AI business cards, and then from invading or hijacking relevant servers or terminal devices, thereby enhancing the security of the terminal device.

In step 102, respond to the first instruction information, and collect audio to obtain first audio data.

Wherein the collected audio may include audio data in the terminal device or human voice data in the environment. The audio data in the terminal device may include recording data, broadcast data, or the audio data of one party in a video call, etc. With such an arrangement, on the one hand, since the audio data in the terminal device can be directly collected, the link of "the terminal device plays the audio data and then collects it again through the microphone" is avoided, and others can be prevented from hearing the target audio to be translated. In this way, in occasions where it is inconvenient to play the sound out loud, such as in meetings and business calls, it can also translate the audio data in the voice messages, recording data, video data, etc. sent by the communication partner, taking into account both privacy and translation efficiency. On the other hand, in scenarios such as video calls and broadcasts, if the audio data needs to be played out loud and then collected, the audio quality may be reduced. Directly using the audio data in the terminal device can improve the audio quality of the first audio data, reduce the impact of noise, and thereby improving the translation efficiency of the electronic device.

It can be understood that the first audio data can be collected by the audio collector such as the microphone built in the terminal device, and it can also be collected by devices that can establish a communication connection with the terminal device, such as a wireless microphone, a wireless headset, a wired headset, a VR device, or AR glasses.

Furthermore, the first audio data can include the human voice data of on-site users such as the person who triggers the trigger button and the holder of the terminal device. It can also include the human voice data of a plurality of speakers which can be distinguished and translated by the server according to characteristic data such as the speaker's voiceprint or the source of the audio data.

In step 103, send the first audio data to a server.

Wherein the server is used to translate the first audio data to obtain a translation result, and send the translation result to the terminal device.

In some embodiments, the translation result may include first text data or second audio data. When a plurality of servers can be involved, for example, the servers may include a first server and a second server; the first server is used to convert the first audio data into first text data, and the second server is used to convert the first audio data or the first text data into second audio data.

In some embodiments, the terminal device can send the first audio data to the first server. Wherein the first server is used to translate the first audio data to obtain the first text data and then send the first text data to the terminal device; the terminal device can send the first text data to the second server; wherein the second server is used to convert the first text data to obtain the second audio data and then send the second audio data to the terminal device.

In some embodiments, the terminal device may send the first audio data to the first server. Wherein the first server is used to translate the first audio data to obtain the first text data and then send the first text data to the terminal device and the second server; the second server is used to convert the first text data to obtain the second audio data and then send the second audio data to the terminal device.

In some embodiments, the terminal device can send the first audio data to the first server and the second server. Wherein the first server is used to translate the first audio data to obtain the first text data and then send the first text data to the terminal device; the second server is used to convert the first audio data to obtain the second audio data and then send the second audio data to the terminal device.

With such an arrangement, a plurality of servers divide the work and complete the translation tasks, thereby enabling a better allocation of translation services and computility resources. This makes it possible to achieve load balancing and an improvement in the translation speed among a plurality of servers or data centers, and the stability and reliability of the overall translation service can be enhanced by using standby servers, and the translation efficiency of the electronic device is improved .

In some embodiments, the terminal device can also collect the first audio data through other terminal devices and send the first audio data to the server via these other terminal devices, and no specific limitation is made here. For example, the translation method based on an AI business card can also be applied to the video communication scenario. The first user can establish a communication connection between the first terminal device and the second terminal device of the second user. When the first user needs to speak, he/she can trigger the trigger button of the first AI business card, thus sending the first instruction information to the first terminal device. The first terminal device receives and responds to the first instruction information, collects the first audio data of the first user, and sends the first audio data to the server. Wherein the server can be used to translate the first audio data to obtain the translation result, and send the translation result to the first terminal device and/or the second terminal device. The first terminal device and/or the second terminal device receive the translation result and output the translation result through the application currently running on each device. With such an arrangement, the second terminal device is equivalent to using the first terminal device to collect audio to obtain the first audio data, using the first terminal device to send the first audio data to the server, and then obtaining and receiving the translation result through the server, thereby outputting the translation result through the application currently running on the second terminal device. With such an arrangement, it can reduce the complexity of the communication link, decrease the number of translation services and audio collections, save communication bandwidth and the computility resources of the server, enhance the stability and smoothness of the overall translation system, and improve the translation efficiency of the electronic device.

In step 104, receive the translation result and output the translation result through a currently running application.

In some embodiments, the translation result may include first text data and/or second audio data. For example, the first text data can be displayed on the display interface of the currently running application in the terminal device; and/or the second audio data can be played through the currently running application. With such an arrangement, users can quickly obtain or apply the translation result, thus improving the translation efficiency of the electronic device.

It can be understood that the second audio data can be played through the loudspeaker built in the terminal device. It can also be played through devices that can establish a communication connection with the terminal device, such as a Bluetooth speaker, a Bluetooth headset, a wired headset, a bone conduction headset, a VR device, or AR glasses.

In some embodiments, the terminal device may be installed with a first application and a second application. Wherein the terminal device can establish a communication connection with the AI business card through the first application. The first application can be regarded as an application developed by the AI business card manufacturer. The second application is any other application except the first application. The second application can be regarded as an application other than the one developed by the manufacturer itself.

In some embodiments, if the application running in the foreground of the terminal device is the first application, then the translation result is output through the first application; or, if the application running in the foreground of the terminal device is the second application, then the translation result is output through the second application, and the first application runs in the background of the terminal device.

With such an arrangement, by keeping the first application in the background and directly outputting the translation result through the second application, users can quickly obtain or apply the translation result, which improves the translation efficiency of the electronic device. Specifically, the first application can be configured as an application capable of implementing a translation function or providing a translation service, and the second application can be configured as any other application except the first application; for example, it can be one of the information applications such as social media, news forums, podcast broadcasts, and chat tools, or it can also be an information application involving text content such as programming software and browsers. For example, the first application can be kept in the background, and any chat tool application different from the first application can be running in the foreground of the user's terminal device, and this chat tool application can be understood as the second application. Users can use the first application to obtain the translation result and directly output the translation result in the information sending box of the currently running chat tool interface, thus avoiding cumbersome operations such as "copying the translation result from the translation software and pasting it into the interface of the second application such as the chat tool", and realizing the function of cross-application translation.

In some embodiments, if the application running in the foreground of the terminal device is the second application and the operating system of the terminal device is Android, the first application can be configured to run in the form of a floating window, picture-in-picture, the background, or a notification; if the application running in the foreground of the terminal device is the second application and the operating system of the terminal device is iOS, the first application can be configured to run in the form of a floating window or picture-in-picture.

With such an arrangement, not only can the first application be kept in the background and the translation result be directly output through the second application, enabling users to quickly obtain or apply the translation result and improving the translation efficiency of the electronic device, but also the first application can be kept in the background in a legal manner. This avoids excessive acquisition of user permissions or accidental deletion by the operating system, which could lead to the interruption of the translation service. As a result, it enhances the translation convenience and efficiency of the terminal device.

In some embodiments, the AI business card sends the second instruction information to the terminal device when the trigger button is triggered again or the trigger state is released. Wherein the terminal device can be used to receive the second instruction information sent by the AI business card; the terminal device responds to the second instruction information and stops to collect audio. With such an arrangement, by sending the second instruction information to the terminal device, the audio collection is stopped promptly, thus enabling the translation function to be stopped promptly, the server to be notified promptly, and the idle computing resources to be fully released, the security, stability and smoothness of the system to be enhanced, and further improving the translation efficiency of the electronic device.

In some embodiments, please refer to FIG. 8. FIG. 8 is a schematic diagram of the display interface of a first application provided in an embodiment of this application. The display interface of the first application can include a first widget 21, a second widget 22, a third widget 23, and a fourth widget 24. Wherein the fourth widget 24 can be configured as a language switching widget.

As shown in FIG. 8, the first widget 21 can be configured as an input widget such as a text editing box. The second widget 22 can be configured as a display widget such as a chat box or a text display area. The third widget 23 can be configured as an interactive widget such as a voice play widget for translation results, a digital human broadcasting widget, or a virtual video generation widget. For example, the translation result can include first text data, and the first text data can be displayed on the display interface of the terminal device through the first widget 21 or the second widget 22. Also, for instance, the translation result can include second audio data, and the second audio data can be played through the third widget 23.

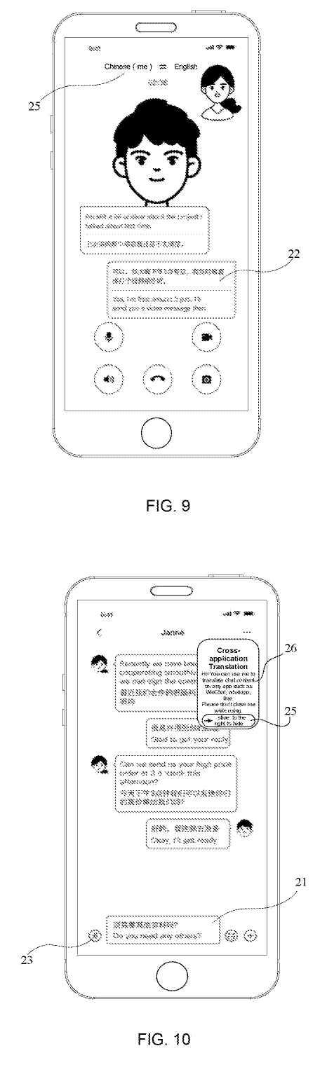

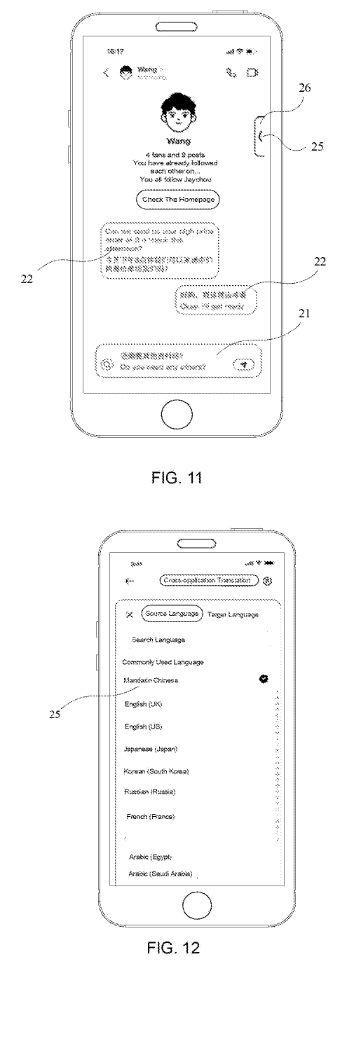

Please also refer to FIGS. 9, 10 and 11. FIG. 9 is a schematic diagram of the display interface of a second application provided in an embodiment of this application. FIG. 10 is a schematic diagram of the display interface of another second application provided in an embodiment of this application. FIG. 11 is a schematic diagram of the display of a video communication interface provided in an embodiment of this application. As shown in FIGS. 9 and 10, the second application can include the first widget 21 and/or the third widget 23, and the first application can be configured to run in the form of a floating window widget or picture-in-picture. As shown in FIGS. 10 and 11, the first application or the second application can also include the second widget 22. With such an arrangement, it is ensured that the translation result can be smoothly, quickly or directly applied through the currently running application, thereby improving the translation efficiency of the electronic device.

It can be understood that one of the above-mentioned first widget 21, second widget 22, and third widget 23 can be configured as an input widget such as a text box, an editing interface, or a selected character. It can also be configured as a display widget such as an information notification, a subtitle bubble, or a text display area. Additionally, it can be configured as an interactive widget such as a voice play button or a button for generating a digital human broadcasting video. No specific limitation is imposed here.

Wherein the pop - up window widget can also be provided with a fifth widget 25. When the first application is configured to run in the form of a floating window widget or picture - in - picture, the pop - up window widget such as the floating window widget or the picture - in - picture widget can have its size adjusted or be hidden on the display interface. As shown in FIGS. 9 and 10, the pop - up window widget can be associated with the fifth widget 25. The size of the pop - up window widget can be adjusted through the fifth widget 25, or the pop - up window widget can be hidden through the fifth widget 25. Wherein the fifth widget 25 can be configured as a virtual sliding key, a virtual exit key, or a virtual button, etc., without specific limitations here.

In some embodiments, the first application, the second application , or the pop - up window widget 26 can also be configured with a fourth widget 24 for switching the source language or the target language. The fourth widget 24 can be a single fourth widget 24, or when triggered, it can jump to or display a language switching interface that includes a plurality of fourth widgets 24. Please refer to FIG. 12. FIG. 12 is a schematic diagram of the display of a language switching interface provided in an embodiment of this application. As shown in the figure, the language switching interface can include a plurality of fourth widgets 24. The fourth widget 24 can correspond to a specific language or specific translation service configuration options, such as source language selection, target language selection, translation service provider configuration, and translation agent API combination. This can improve the quality of the translation results and the flexibility of translation tasks, thereby enhancing the translation efficiency of the electronic device.

It can be understood that the schematic diagrams of the display interfaces or the display provided in the embodiments of this application are merely schematic diagrams of some of the display interfaces related to the solutions of this application, and do not constitute a limitation on the terminal devices to which the solutions of this application are applied. The specific display interface can include more or fewer widgets than those shown in the figures, or combine certain widgets, or have different arrangements of widgets.

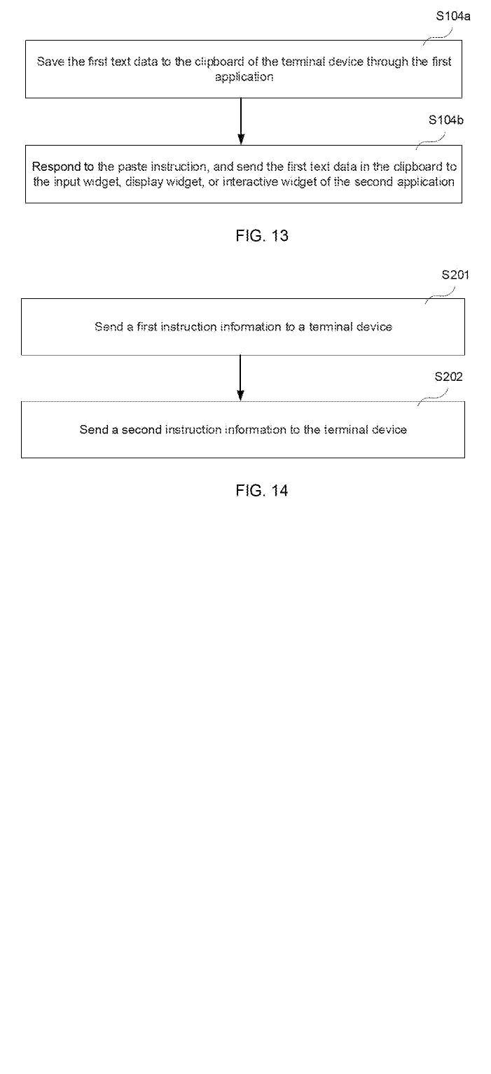

In some embodiments, please refer to FIG. 13, FIG. 13 is a schematic flowchart of a translation method based on an AI business card provided in an embodiment of this application. The translation method is applied to the terminal device. The translation method based on an AI business card can include the following steps.

In step 104a, save the first text data to the clipboard of the terminal device through the first application.

Wherein the first text data can be received through the network port of the first application and saved to the clipboard of the terminal device; or, the first text data that the terminal device has previously received and saved in the memory,can be read through the first application, and then save it to the clipboard of the terminal device.

It can be understood that the operating system imposes certain permission restrictions on the direct interaction between background programs and foreground applications. Background programs usually do not have the permission to directly operate the interfaces of foreground applications. However, the clipboard, as a public data storage area, provides a relatively secure way for data exchange, allowing programs to copy and paste data with the user's authorization. That is, by uniformly saving the first text data to the clipboard of the terminal device, it can prevent the first application from directly operating the relevant interfaces of the second application, which improves the security and stability of the device's operating system and enhances the translation efficiency of the electronic device.

It can be further understood that when using the clipboard for data input, users can clearly know the source of the data. Users can actively choose whether to copy the data generated by the background program to the clipboard and decide when to paste it into the foreground application, thereby enhancing their sense of control and autonomy over the data input process. Moreover, if the background program could directly input data into the foreground application, it might disrupt the user's current operations. For example, if a user is editing an important text in a foreground application and the background program suddenly inserts an irrelevant piece of text, it would disrupt the user's train of thought and reduce work efficiency. By using the clipboard, users can paste the data at an appropriate time, avoiding interference with their current tasks. In addition, with the clipboard method, users can paste and modify the same data in a plurality of applications, which improves user convenience and usage efficiency.

In step 104b, respond to the paste instruction, and send the first text data in the clipboard to the input widget, display widget, or interactive widget of the second application.

Wherein the form of the paste instruction can be an HID code. The HID code is an encoding method based on the communication protocol of the USB standard. Since most terminal devices and operating systems support the USB standard by default, the HID code can be used on a plurality of operating systems without the need to install additional drivers. This makes the first application and the AI business card device have broader applicability and compatibility by using the HID code to paste. They can smoothly execute translation tasks in various operating systems such as Windows, Android, and iOS. Moreover, when the AI business card is used for the first time, there is no need to install more communication drivers in the terminal device. As a result, it reduces the user's learning cost, decreases the capacity and computility consumption of the first application, improves the installation efficiency of the first application and the stability and smoothness of the operation of the terminal device's system, and enhances the translation efficiency.

In some embodiments, the translation result includes the first text data. The ways to output the translation result through the second application can include: save the first text data to the clipboard of the terminal device through the first application; send the first text data to the input widget, display widget, or interactive widget of the second application through the clipboard. For example, the input widget, display widget, or interactive widget can be configured as a text box, a chat box, a text display area, a subtitle area, etc. It can include widgets that can only perform text display functions and/or widgets that can perform text editing functions. It can also be a selected editable area, a text editor, an integrated development environment, etc.

Wherein, before the step of sending the first text data to the input widget, display widget, or interactive widget of the second application through the clipboard, a confirmation pop - up window can be displayed. This is to apply the content in the clipboard after obtaining the user's consent, thereby reducing security risks such as malicious software using the clipboard to input malicious code. Alternatively, the content in the clipboard can be directly applied, improving efficiency.

An embodiment of this application further provides a translation method based on an AI business card. Please refer to FIG. 14, FIG. 14 is a schematic flowchart of a translation method based on an AI business card provided in an embodiment of this application. The translation method based on an AI business card can be applied to an AI business card. Specifically, it can include the following steps.

In step 201, send a first instruction information to a terminal device.

Wherein the AI business card can be attached to the terminal device, the AI business card is provided with a trigger button, and the AI business card sends the first instruction information to the terminal device when the trigger button is triggered; the terminal device responds to the first instruction information, collects audio to obtain first audio data, and sends the first audio data to a server; the server is used to translate the first audio data to obtain a translation result and send the translation result to the terminal device.

In step 202, send a second instruction information to the terminal device.

Wherein the AI business card sends the second instruction information to the terminal device when the trigger button is triggered again or the trigger state is released, the terminal device responds to the second instruction information and stops to collect audio.

It can be understood that the translation method based on the AI business card proposed in this application, on the one hand, realizes the translation function according to the instruction information sent by the AI business card, which can avoid the cumbersome operations and inconveniences of "constantly switching the software display interface and using the clipboard to copy and paste the information in the translation software into the target application ", and improve the translation efficiency of the electronic device. On the other hand, the method enhances the flexibility and controllability of the translation service by invoking the server to execute the translation function, and makes it possible for users to build, train and use translation agents, set up a unified translation glossary, and customize translation services; it also potentially makes users to efficiently combine and use better translation services in various languages, thus improving the translation efficiency of the electronic device. Furthermore, it saves the computing resources of the terminal device and the AI business card by invoking the server to execute the translation function, making the terminal device and the AI business card more lightweight and compact, and enabling the system of the terminal device to run more smoothly. In addition, since the AI business card can be attached to the terminal device, this not only makes the AI business card less likely to be lost, avoiding the risk of being easily lost due to its miniaturization, but also enables users to conveniently operate the translation function with a single-handed grip when using the terminal device such as a mobile phone, thus improving the translation efficiency of the terminal device. Moreover, since the translation result is output through the currently running application after receiving the translation result, it can take into account various scenarios such as the currently running translation software, video calls, chat tools, online forums, or social media. This enables users to obtain or apply the translation result simply and quickly. In particular, it makes it possible to directly output the translation result in the form of subtitles or transcribed speech during a video call, improving the translation efficiency of the electronic device. Additionally, in the related art, when the audio collection task is executed by a traditional external translator, frequent and large-volume communication between the terminal device and the external translator is required, which not only occupies the communication bandwidth of both the terminal device and the external translator but also makes the external translator have higher requirements for electronic components such as the power supply and communication module. Therefore, by invoking the terminal device to execute the audio collection task, the requirements for the components of the AI business card can be reduced. Not only can the volume be reduced by canceling the audio collection module, but also a longer battery life can be obtained, preventing the user from interrupting the translation work frequently due to the need for charging, and improving the translation efficiency of the electronic device. Furthermore, since functions such as audio collection function are controlled through the trigger button of the AI business card, it has higher security, reducing the risk of viruses in the terminal device disguising and hijacking the interfaces related to the translation service for activities such as secretly recording audio and occupying bandwidth, avoiding the decline in the system security and smooth operation of the terminal device, and improving the translation efficiency of the electronic device.

The embodiments of this application provide an AI business card, which can be used to execute any of the translation methods applied to the AI business card provided in the above-mentioned embodiments.

It should be noted that those skilled in the art can clearly understand that, for the sake of convenience and conciseness of description, the specific working processes of the above-described device and each module can refer to the corresponding processes in the foregoing method embodiments, and will not be repeated here.

An embodiment of this application further provides a computer-readable storage medium. The computer-readable storage medium stores a computer program, the computer program includes program instructions, when the program instructions are executed by a processor, the processor implements the translation method based on an AI business card as described in any embodiment of this application.

The computer-readable storage medium can be an internal storage unit of the aforementioned terminal device, such as the hard disk drive or memory of the terminal device. The computer-readable storage medium can also be an external storage device of the terminal device, such as a pluggable hard disk drive, a smart media card (SMC), a secure digital (SD) card, a flash card equipped on the terminal device.

The aforementioned descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A translation method based on an AI business card, applied to a terminal device, comprising:
receiving first instruction information sent by an AI business card, wherein the AI business card is attached to the terminal device, the AI business card is provided with a trigger button, and the AI business card sends the first instruction information to the terminal device when the trigger button is triggered;
responding to the first instruction information, and collecting audio to obtain first audio data;
sending the first audio data to a server, wherein the server is used to translate the first audio data to obtain a translation result, and send the translation result to the terminal device; and
receiving the translation result and outputting the translation result through a currently running application.

2. The method according to claim 1, wherein the translation result comprises first text data or second audio data; the outputting the translation result through a currently running application comprises:
the first text data is displayed on a display interface of the currently running application in the terminal device; or
the second audio data is played through the currently running application.

3. The method according to claim 1, wherein the terminal device is installed with a first application and a second application; wherein the terminal device establishes a communication connection with the AI business card through the first application, and the second application is any other application except the first application; the outputting the translation result through a currently running application comprises:
if an application running in a foreground of the terminal device is the first application, the translation result is output through the first application; or
if an application running in a foreground of the terminal device is the second application, the translation result is output through the second application, and the first application runs in a background of the terminal device.

4. The method according to claim 3, wherein the translation result comprises first text data; the the translation result is output through the second application comprises:
saving the first text data to a clipboard of the terminal device through the first application; and
sending the first text data to an input widget, a display widget or an interactive widget of the second application through the clipboard.

5. The method according to claim 3, wherein if the application running in the foreground of the terminal device is the second application and an operating system of the terminal device is Android, the first application is configured to run in a form of a floating window, picture-in-picture, the background, or a notification; or
if the application running in the foreground of the terminal device is the second application and an operating system of the terminal device is iOS, the first application is configured to run in a form of a floating window or picture-in-picture.

6. The method according to claim 3, wherein the AI business card sends second instruction information to the terminal device when the trigger button is triggered again or a trigger state is released; the the translation method based on an AI business card further comprises:
receiving the second instruction information sent by the AI business card; and
responding to the second instruction information, and stopping to collect audio.

7. The method according to claim 6, wherein the second instruction information comprises a paste instruction, the translation result comprises first text data; the outputting the translation result through a currently running application comprises:
saving the first text data to a clipboard of the terminal device through the first application; and
responding to the paste instruction, and sending the first text data in the clipboard to an input widget, a display widget or an interactive widget of the second application, wherein a form of the paste instruction is an HID code.

8. The method according to claim 1, wherein the AI business card comprises a Bluetooth module and an NFC module, wherein the AI business card establishes an encrypted communication connection with the terminal device through the Bluetooth module, the AI business card sends business card information to the terminal device through the NFC module, and the business card information comprises web links, content information or log information.

9. The method according to claim 8, wherein the first instruction information comprises authentication information, the receiving first instruction information sent by an AI business card comprises:
performing authentication based on the authentication information sent by the AI business card; and
if an authentication result is unsuccessful, the step in response to the first instruction information will not be executed.

10. The method according to claim 1, wherein the translation result comprises first text data or second audio data; the server comprises a first server and a second server, the sending the first audio data to a server comprises:
sending the first audio data to the first server, wherein the first server is used to translate the first audio data to obtain the first text data and send the first text data to the terminal device; and
sending the first text data to the second server, wherein the second server is used to convert the first text data to obtain the second audio data and send the second audio data to the terminal device.

11. The method according to claim 1, wherein the translation result comprises first text data or second audio data; the server comprises a first server and a second server, the sending the first audio data to a server comprises:
sending the first audio data to the first server, wherein the first server is used to translate the first audio data to obtain the first text data and send the first text data to the terminal device and the second server, and the second server is used to convert the first text data to obtain the second audio data and send the second audio data to the terminal device.

12. The method according to claim 1, wherein the translation result comprises first text data or second audio data; the server comprises a first server and a second server, the sending the first audio data to a server comprises:
sending the first audio data to the first server and the second server, wherein the first server is used to translate the first audio data to obtain the first text data and send the first text data to the terminal device, and the second server is used to convert the first audio data to obtain the second audio data and send the second audio data to the terminal device.

13. The method according to claim 1, wherein the first audio data comprises human voice data of a plurality of speakers, the server distinguishes and translates the human voice data according to characteristic data, wherein the characteristic data comprises the speaker's voiceprint or a source of audio data.

14. A terminal device, comprising:
a memory, configured to store a computer program;
a processor, configured to execute the computer program and implement a translation method based on an AI business card according to claim 1.

15. An AI business card, comprising:
a housing;
a communication module, through which the AI business card establishes a communication connection with a terminal device, and the communication module includes a Bluetooth module or an NFC module;
a trigger button, the trigger button is provided on the housing, configured to make the AI business card send first instruction information when triggered, or send second instruction information when triggered again or when a trigger state is released;
wherein the communication module is used to send the first instruction information to the terminal device, the AI business card is attached to the terminal device, the AI business card sends the first instruction information to the terminal device when the trigger button is triggered, the terminal device responds to the first instruction information, collects audio to obtain first audio data, and sends the first audio data to a server, the server is used to translate the first audio data to obtain a translation result and send the translation result to the terminal device.

16. The AI business card according to claim 15, wherein the AI business card further comprises an attachment piece, the AI business card is detachably attached to the terminal device through the attachment piece.

17. The AI business card according to claim 16, wherein the attachment piece comprises magnetic components, hook-and-loop fasteners, micro suction cups or rubber sleeves.

18. A translation system, comprising:
a server;
an AI business card, configured to be attached to a terminal device and be in communication connection with the terminal device, the AI business card is provided with a trigger button, and the AI business card sends a first instruction information to the terminal device when the trigger button is triggered;
a terminal device, configured to be in communication connection with the server, the terminal device is configured to execute the following steps:
receiving the first instruction information sent by the AI business card;
responding to the first instruction information, and collecting audio to obtain first audio data;
sending the first audio data to the server, wherein the server is used to translate the first audio data to obtain a translation result, and send the translation result to the terminal device; and
receiving the translation result and outputting the translation result through a currently running application.

19. A translation system according to claim 18, wherein the AI business card is configured to execute the following step:
sending a second instruction information to the terminal device when the trigger button is triggered again or a trigger state is released, wherein the terminal device responds to the second instruction information and stops to collect audio.

20. A computer-readable storage medium, wherein the computer-readable storage medium stores a computer program, when the computer program is executed by a processor, the processor implements a translation method based on an AI business card according to claim 1.
